(19) United States
(12) Patent Application Publication
(10) Pub. No.: US 2015/0200813 A1
(43) Pub. Date: Jul. 16, 2015

(54) SERVER CONNECTION APPARATUS AND SERVER CONNECTION METHOD

(71) Applicant: ELECTRONICS AND TELECOMMUNICATIONS RESEARCH INSTITUTE, Daejeon (KR)

(72) Inventors: Byung Joon LEE, Daejeon (KR); Ji Soo SHIN, Daejeon (KR); Sae Hyong PARK, Daejeon (KR)

(21) Appl. No.: 14/596,301

(22) Filed: Jan. 14, 2015

(30) Foreign Application Priority Data
Jan. 15, 2014 (KR) 10-2014-0004902
Dec. 24, 2014 (KR) 10-2014-0188825

(51) Int. Cl. H04L 12/24; H04L 29/08

(52) U.S. Cl. CPC H04L 41/12; H04L 67/10

(57) ABSTRACT

A server connection apparatus and method for controlling a connection between a plurality of controller servers and a plurality of network devices. The server connection apparatus includes a network connector configured to connect a plurality of controller servers capable of functioning as OpenFlow protocol-based SDN controllers and a plurality of network devices on a data plane and relay transmission and reception of data between the controller servers and the network devices; and a controller configured to create a list of available controller servers by monitoring an operational state of each controller server, select a particular controller server to be in charge of controlling a network device in response to a received request, and then control connection relationships between the plurality of controller servers and the plurality of network devices based on the selection result.

### CROSS-REFERENCE TO RELATED APPLICATION(S)

This application claims priority from Korean Patent Application Nos. 10-2014-0004902, filed on Jan. 15, 2014, and 10-2014-0188825, filed on Dec. 24, 2014 in the Korean Intellectual Property Office, the disclosures of which are incorporated herein by references in its entirety.

BACKGROUND

1. Field

The following description relates to an apparatus and method for connecting servers, and more particularly, to a server connection apparatus for controlling connection relationships between a plurality of network devices and a plurality of controller servers and a server connection method.

2. Description of the Related Art

Network control technologies using OpenFlow switches separate a data plane and a control plane and enable the provision of a variety of integrated services, regardless of characteristics and forms of the underlying transport network. Through what is called the Software Define Network (SDN), network routing as well as control and complex operation management can be easily dealt with through software programming. For implementation of SDN, OpenFlow protocols are used and a standard public interface between communication service logic and a communication network is provided.

The existing high availability, high scalability strategies using OpenFlow protocols require IP addresses of all controller nodes to be set in a switch in advance. The switch is connected to a controller with the smallest load among associated nodes. This method, however, requires IP addresses of all nodes belonging to a controller cluster to be input to the switch. Generally, only a limited number of IP addresses can be input, and hence it may not be possible, when using the method mentioned above, to increase the size of a cluster beyond a certain point.

### SUMMARY

In one general aspect, there is provided a server connection apparatus including: a network connector configured to connect a plurality of controller servers capable of functioning as OpenFlow protocol-based Software Define Network (SDN) controllers and a plurality of network devices on a data plane, and relay transmission and reception of data between the controller servers and the network devices; and a controller configured to create a list of available controller servers by monitoring an operational state of each controller server, select a particular controller server to be in charge of controlling a network device in response to a received request, and then control connection relationships between the plurality of controller servers and the plurality of network devices based on the selection result.

In another general aspect, there is provided a server connection method including: a preparation process comprising creating a list of available controller servers among a plurality of controller servers by monitoring an operational state of each controller server in a run-time environment; an execution process comprising, in response to receiving a request for instruction to process a packet or a request for connection to a controller server from a network device on a data plane, selecting a particular controller server to be in charge of controlling a network device from among the plurality of controller servers, and controlling connection relationships between the plurality of controller servers and the plurality of network devices based on the selection result; and a monitoring process comprising performing at least one of operations including change, deletion, and addition of the selected controller server based on a received feedback about the operational state of each controller server.

The monitoring process may include, when an amount of traffic load generated in the selected controller server is greater than a predetermined threshold, adding a new controller server or changing the current controller server to another controller server.

Other features and aspects will be apparent from the following detailed description, the drawings, and the claims.

### BRIEF DESCRIPTION OF THE DRAWINGS

FIG. 1 is a block diagram illustrating a network control system using a server connection apparatus, according to an exemplary embodiment.

FIG. 2 is a block diagram illustrating a server connection apparatus according to an exemplary embodiment.

FIG. 3 is a table showing examples of a server list and a session list.

FIG. 4 is a flowchart illustrating a server connection method according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present invention now will be described more fully hereinafter with reference to the accompanying figures. In the following description, a detailed description of known functions and configurations incorporated herein will be omitted when it may obscure the subject matter with unnecessary detail. Terms used throughout this specification are defined in consideration of functions according to exemplary embodiments, and can be varied according to a purpose of a user or manager, or precedent and so on. Therefore, definitions of the terms should be made on the basis of the overall context.

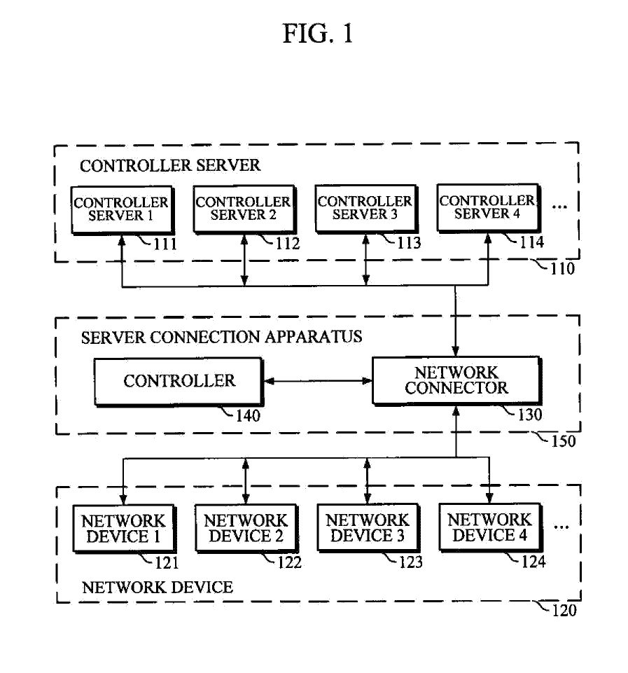

FIG. 1 is a block diagram illustrating a network control system using a server connection apparatus according to an exemplary embodiment.

According to an exemplary embodiment, each network device 120 may have a controller server 110 to be in charge of controlling the network device and one network device 120 may be connected to a plurality of controller servers 110.

A server connection apparatus 150 is connected to each controller server 110 and each network device 120. Network device 1 121, network device 2 122, network device 3 123, and network device 4 124 may transmit and receive packets to and from controller server 1 111, controller server 2 112, controller server 3 113, and controller server 4 114 through a network connector 130 of the server connection apparatus 150.

The network connector 130 connects the plurality of controller servers 110 capable of functioning as OpenFlow protocol-based SDN controller and a plurality of network devices 120 on a data plane and relays the transmission and reception of data between the controller servers 110 and the network devices 120. The network connector 130 plays the same role as an OpenFlow switch, collecting packets from the network devices 120 and querying the controller 140 regarding packet processing.

The controller 140 creates a list of available controller servers by monitoring an operational state of each controller server 110, selects a particular controller server 110 to be in charge of controlling a network device 120 in response to a received request, and then controls connection relationships between the plurality of controller servers and the plurality of network devices based on the selection result.

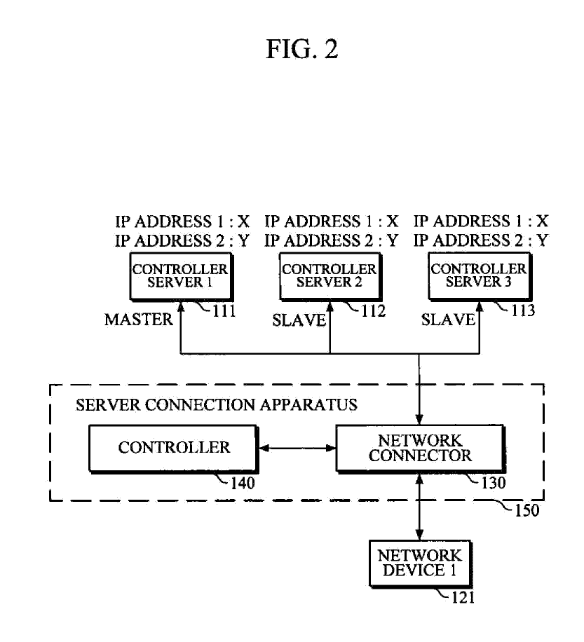

The server connection apparatus 150 may connect each of the plurality of controller servers 110 to each of the plurality of network devices 120 and store a list of connection relationships therebetween. This will be described below with reference to FIG. 2.

FIG. 2 is a block diagram illustrating a server connection apparatus according to an exemplary embodiment.

A server connection apparatus 150 may include a network connector 130 and a controller 140.

The network connector 130 may periodically receive RUNNING packets from controller servers 1, 2, and 3 111, 112, and 113, and may receive SHUTDOWN packets in the event where the controller server is not able to operate. In this case, each controller server may have the same runtime environment installed therein. The network connector 130 periodically receives RUNNING packets while the controller servers are running in the run-time environment, and receives SHUTDOWN packets when a currently running application is determined to be unable to run any longer in the run-time environment due to some errors in the application.

According to an exemplary embodiment, the network connector 130 may provide network device 1 121 with information about two representative IP addresses to gain access to controller servers 1, 2, and 3 111, 112, and 113. The provided representative IP addresses are chosen from representative IP addresses allocated to each controller server, and allow for the connection from network device 1 121 to the controller servers. The network connector 130 may be controlled by the controller 140 to periodically transmit an ARP message regarding the representative IP address to a particular port among physical ports which is connected to the network device. In this case, the network connector 130 connects network device 1 121, which is capable of simultaneously accessing a plurality of controller servers 111, 112, and 113, to the controller servers using two IP addresses. One IP address may be connected to master controller server 1 111 and the other IP address may be connected to slave controller server 2 112. A network device 121 that is not capable of simultaneously accessing a plurality of controller servers may access controller server 1 111 using a single IP address, and at this time, the accessed controller server may be a master controller server.

In response to receiving a packet indicating the execution or termination of run-time software from each controller server 111, 112, and 113, the network connector 130 may issue a query to the controller 140 regarding packet processing. For example, when the run-time software is executed, the network connector 130 receives a RUNNING packet from each of the controller servers 111, 112, and 113, and when the software is terminated or connection is abnormally shut down, the network connector 130 receives a SHUTDOWN packet. The network connector 130 may request the query about how to process the received packet.

More specifically, in response to receiving a RUNNING packet, the network connector 130 queries the controller 140 about how to process the received packet by sending the controller an OpenFlow PACKET_IN message. In this case, the controller 140 does not send back any replay regarding the query, which then prompts the network connector 130 to discard the packet. In addition, the network connector 130 may receive a SHUTDOWN packet from the controller servers 111, 112 and 113 when the run-time software is abnormally terminated. In response to receiving the SHUTDOWN packet, the network connector 130 queries the controller 140 regarding packet processing by sending an OpenFlow PACKET_IN message (containing the SHUTDOWN packet). The controller 140 does not send back a reply regarding the query, which prompts the network connector 130 to discard the packet. In addition, in response to receiving a connection request packet for connection to the controller server from network device 1 121 on the data plane, the network connector 130 queries the controller 140 by sending an Openflow PACKET_IN message about how to process the received packet. In this case, a destination IP address of the connection request packet may be one of the representative IP addresses.

If, in response to the query, the controller 140 sends an OpenFlow FLOW_MOD message that includes connection information between the network device 1 121 and the controller server 1 111 that is chosen to control the network device 1 121, the network connector 130 sets a processing direction of packets according to the information about connection so that the packets are transmitted to the controller server 1 111 from the network device 1 121 on the data plane. In addition, the response from controller server 1 111 is set to be sent to data plane network device 1 121 via the network connector 130. The FLOW_MOD message may include the following: 1) an instruction that transforms a representative IP address or MAC address that have been used by the network connector 130 as destination addresses into actual MAC or IP addresses of controller server 1 111; 2) an instruction that transforms actual IP or MAC addresses of the controller server 1 111 which is used by the network connector 130 as a sender address into an actual MAC address or representative IP address.

The controller 140 creates a list of available controller servers by monitoring the operational state of each controller server 1, 2, and 3 111, 112, and 123, and in response to a request from the network connector 130, selects controller server 1 111 to be in charge of controlling network device 1 121. Furthermore, the controller 140 controls the connection relationship between the plurality of controller, servers and the plurality of network devices based on the selection result.

More specifically, the controller 140 checks the type of packet received through the network connector 130, and identifies the operational state of each controller server based on the execution or termination status of run-time software of each controller server 111, 112, and 113.

For example, in response to receiving an OpenFlow PACKET_IN message that contains a RUNNING packet from the network connector 130, the controller 140 determines that software of a particular controller server 1 111 that has sent the OpenFlow PACKET_IN message is in executable state. The controller 140 may store the actual IP address of controller server 1 111, the reception time of the latest RUNNING packet, and a port number of the network connector 130 to which controller server 1 111 is connected in a server list. Each time the network connector 130 receives a RUNNING packet from controller server 1 111, the controller 140 receives a packet that is included in an OpenFlow PACKET_IN message from the network connector 130, and updates the reception time of the latest RUNNING packet from controller server 1 111. This information may be utilized to detect whether errors occur in controller server 1 111.

In addition, the controller 140 may detect the abnormal termination of run-time software by analyzing a query packet delivered by the network connector 130. For example, the controller 140 analyzes a RUNNING packet contained in the query packet, determines whether a state during which a RUNNING packet has not been received from the controller server 2 112 is maintained for more than a predetermined period of time If the state is continued for more than the predetermined period of time, the controller 140 performs the same process as when receiving a query message that includes a SHUTDOWN packet from the particular controller server 2 112.

In addition, in response to receiving an OpenFlow PACKET_IN message that contains a SHUTDOWN packet from the network connector 130, the controller 140 determines that a corresponding controller server is in a disabled state. For example, when controller server 1 111 has entered into a disabled state, the controller 140 commences processing for selecting a new master controller server for network device 1 121 that had been connected to the controller server 1 111. For example, if the disabled controller server 1 111 was a master server for the network device 1 121, the controller 140 converts either one of the slave controller servers 112 or 113, which had been connected to the network device 1 121 into a master controller server, and if there is slave controller server already connected to the network device 1 121, the controller 140 lets the network device 1 121 attempt re-connection to the controller server. Further, if the disabled controller server 3 113 had been a slave server of the network device 1 121, the controller 140 may also let the network device 1 121 autonomously restore the slave connection.

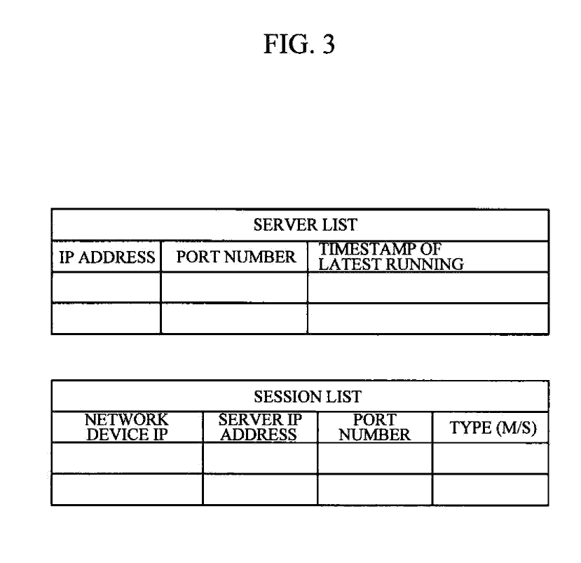

In response to receiving an OpenFlow PACKET_IN message that contains a TCP SYN packet that requests connection to a controller server from the network connector 130, the controller 140 selects a controller server. Since a controller server is individually selected for each network device 121 that has issued a connection request, one controller server 1 111 may be selected as either a master or slave controller server for many different network devices. The controller 140 may store the connection relationship between the network device 1 121 and the controller server 1 111 in a list storage. This process will be described with reference to FIG. 3. Selection of a controller server may be performed with reference to a server list and a session list table, and more specifically, a controller server that is in charge of a particular network device may be selected from the plurality of controller servers 110 with reference to packet header fields, the existing connections between the network devices and the controller servers, and the amount of traffic on each controller server. Various methods for selecting a controller server may be used, and aspects of the present disclosure are not limited to the embodiments described hereinabove.

In response to selecting, a particular controller server 110, the controller 140 transmits an OpenFlow FLOW_MOD message regarding packet processing to the network connector 130, and the then, conducts monitoring of traffic load, role description, and packet flow.

If the controller 140 receives a request for connection to a controller server from the network device 1 121 several times, the controller 140 designates the controller server 1 that was first selected as the master 111 and the other controller servers 2 and 3 that were later selected as slaves 112 and 113. Whether the controller server was selected first or not may be determined with reference to a session list table. In addition, the controller 140 may transmit a message that provides role description to a particular controller server. The role description may relate to whether the controller server is a master or a slave. The controller 140 may transmit role description about a role of controller server 1 111 with respect to network device 1 121 to the controller server 1 111 through the network connector 130. For example, if the controller server 1 111 acts as a master with respect to the network device 1 121, the controller 140 transmits the role description to the controller server 1 121 through the network connector 130. The controller server 1 111 that has received a corresponding message informs the network device 1 121 through the network connector 130 that the controller server 1 111 itself is the master. In another example, if controller server 2 112 acts as a slave with respect to the network device 1 121, the controller 140 transmits role description to the controller server 2 112 through the network connector 130. The controller server 2 112 that has received a corresponding message informs the network device 1 121 through the network connector 130 that the controller server 2 112 itself is the slave. In this case, each controller server may utilize a ROLE_REQUEST message of OpenFlow protocol to inform its role description to the network device 1 121.

In another exemplary embodiment, in a case where the amount of traffic load generated in a selected controller server is greater than a predetermined threshold, or where a new controller server is added, the controller 140 may change the controller server connected to the network device to another controller server. For example, if it is determined that excessive traffic load has been generated in the controller server 1 111, the controller 140 may migrate all or some of the network devices that are using the controller server 1 111 as their master to another controller server. When the controller 140 is to migrate the network device 1 121 from a current controller server to another controller server, the controller 140 may check whether a slave controller server connected to the network device 1 121 exists or not. If the controller server 2 112 were the connected slave controller server, the controller 140 sends a message to the controller server 2 112 to instruct it to change its role from a slave to a master with respect to the network device 1 121. Also, the controller 140 sends a message to the controller server 1 111 to instruct it to change its role from a master to a slave with respect to the network device 1 121. Each controller server 1 and 2 111 and 112 that has received the message that informs the change of role sends a message to the network device 1 121 to inform that its role has changed. The message to be sent to inform of the role change may be a ROLE_REQUEST message of OpenFlow protocol.

If no slave controller server is connected to the network device 1 121, the controller 140 may send a FLOW_DEL message to the network connector 130 to delete connection information between the network device 1 121 and the controller server 1 111, and also delete internally stored connection information. In addition, the controller 140 sends a message to the controller server 1 111 through the network connector 130 to forcibly disconnect the controller server 1 111 from the network device 1 121. The disconnected network device 1 121 may attempt re-connection to the controller server 110 to recover from the forcibly terminated connection and this connection attempt may be routed to another controller server that has a smaller load. The above-described process may be repeated for all of the network devices subject to migration to different controller servers. There are various methods that determine whether the traffic load is excessive, and such methods are not limited to any one in particular.

FIG. 3 is a table showing examples of a server list and a session list. Referring to FIG. 3, the controller 140 creates a server list to manage a plurality of controller servers 110, wherein the server list includes IP addresses, MAC addresses, port numbers, and reception time of the latest RUNNING packet from each controller server. In addition, the controller 140 creates a session list that shows relations between each network device 120 and each controller server 110. The session list may include network device IPs, MAC addresses of network devices, controller server IP addresses, port numbers to which each controller server is connected, and a description of what type of controller server each is. At this time, a controller server type may be described as a master or a slave.

In another exemplary embodiment, if an item to represent an IP of each network device 120 is not present in the session list or if a master controller server with respect to the data plane network device 120 has not been determined yet, for example, if there is no record that indicates a master, (“type=M”), the controller server 110 sends an OpenFlow ROLE_REQUEST message to the data plane network device 121 to indicate that the controller server 110 itself is a master controller server. However, if there is a previously determined master controller server (or the session list includes a record that shows “type=M” with respect to an IP of a network device), the server connection apparatus sends a PACKET_OUT message to the controller server 110 to modulate a TCP SYN packet and transmit the modulated TCP SYN packet, and the controller server 110 that has received the modulated TCP SYN packet changes its operational state to a slave. The controller server 110 sends a ROLE_REQUEST message to the server connection apparatus, and in response to the ROLE_REQUEST message, the server connection apparatus updates the session list by changing what the controller server type is.

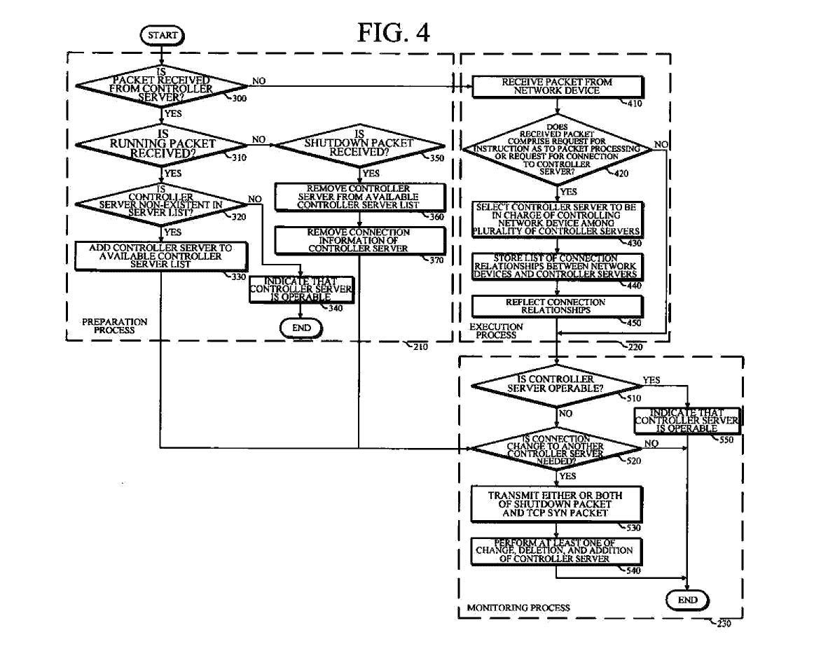

FIG. 4 is a flowchart illustrating a server connection method using the server connection apparatus of FIG. 1 according to an exemplary embodiment.

The server connection method may include preparation process 210, execution process 220, and monitoring process 230. In addition, the server connection method may further include a process which stores a list about relationships between a plurality of controller servers and a plurality of network devices.

The server connection apparatus determines in 300 whether or not it receives from a controller server a packet that indicates an operational state of the controller server. If the server connection apparatus receives the packet from the controller server, the flow proceeds to preparation. In the preparation, a list of controller servers available among the plurality of controller servers is created and managed. In one exemplary embodiment, the server connection apparatus receives from a controller server a RUNNING or SHUTDOWN packet that indicates an operational state of the controller server.

More specifically, in response to receiving a RUNNING packet, the server connection apparatus determines whether the received packet is a RUNNING packet or not in 310. The network connector of the server connection apparatus creates a query about packet processing by sending an OpenFlow PACKET_IN message, and transmits the query to the controller of the server connection apparatus. In response to the created query, the server connection apparatus updates a list of available controller servers using information about an IP address of a controller server, a port number of the network connector through which the RUNNING packet is received, and the time at which the latest RUNNING packet was observed. If the RUNNING packet is received, the server connection apparatus determines whether or not the controller server that has transmitted the RUNNING packet is absent from a server list in 320. If the controller server exists in the server list, the server connection apparatus indicates that the controller server is operable in 340. If the controller server is absent from the server list, the server connection apparatus adds the controller server to the server list as an available controller server in 330. Then, the flow may proceed to the monitoring process 520 to determine whether connection change to another controller server is needed or not.

If the received packet from the controller server is not a RUNNING packet, the server connection apparatus determines whether the received packet is a SHUTDOWN packet or not in 350. When run-time software ends, the server connection apparatus receives a SHUTDOWN packet (including an address of the disconnected server) from the controller server. In the server connection apparatus, the network connector creates a query about packet processing, and transmits the created query to the controller 140 using an OpenFlow PACKET_IN message, and the controller of the server connection apparatus determines whether the run-time software that has been operating at a particular MAC address of the controller server has ended based on the query, and concludes that the controller server is in a disabled state. The server connection apparatus removes the controller server from the list recorded as available controller servers in 360, and deletes connection information regarding the removed controller server in 370. Then, the flow proceeds to monitoring process 520 to determine whether connection change to another controller server is needed or not. This process will be described below.

The flow may proceed to monitoring operation 520 to determine whether connection change to another controller server is needed or not.

The server connection apparatus may have not received any packet from the controller server. In the execution process 220, the server connection apparatus may have received a packet from a network device in 410. The server connection apparatus determines whether the received packet from the network device comprises a request for instruction regarding packet processing or a request for connection to a controller server in 420. The server connection apparatus selects the controller server to be in charge of controlling the network device among a plurality of controller servers in 430, and control relationships between each controller server and each network device based on the selection information. If the request for instruction about the packet processing or the request for connection to a controller server is not received in 420, the flow proceeds to the monitoring process.

More specifically, the server connection apparatus receives a request for connection to a controller server from the network device on the data plane. The server connection apparatus creates a query message to select a controller server from among the plurality of controller servers. The server connection apparatus selects a particular control server to be in charge of controlling the network device among the plurality of controller servers with reference to the server list and the session list. More specifically, the server connection apparatus references packet header fields, existing connections between the network devices and the controller servers, and the amount of traffic load on each controller server. Various methods for selecting a controller server may be used, and aspects of the present disclosure are not limited to the embodiments described hereinabove.

In another exemplary embodiment, in the execution process in 220, if a particular controller server has been previously selected, the server connection apparatus transmits the received packet from the network device to the selected controller server. The server connection apparatus transmits a response from the controller server to the network device.

In addition, in the execution process in 220, the server connection apparatus manages the controller server list and the list about relationships between each controller server and each network device.

Also, in the execution process in 220, when a plurality of controller servers are selected, the server connection apparatus chooses one of the selected controller servers as a master controller server and the other controller servers may be determined as slave controller servers.

Based on the selection of the controller server(s), the server connection apparatus stores a list about connection relationships between the network device and each of the selected controller servers in 440, and reflects the connection relationships in controlling the network in 450.

In the monitoring process 230, the server connection apparatus monitors the operational state of the controller server. And if needed, a plurality of network servers connected to the controller server are re-connected to other controller servers. The monitoring process is periodically performed or arbitrarily performed of other processes.

The server connection apparatus determines whether the controller server is operable in 510. If the controller server is operable, the server connection apparatus indicates that the controller server is operable in 550. However, if the controller server is disabled, for example, if the server connection apparatus determines that a state in which the server connection apparatus has not received any packet from the controller server is maintained for more than a predetermined period of time since the latest RUNNING packet is received. Then, the server connection apparatus determines that the controller server has been terminated abnormally. In addition, the server connection apparatus determines whether connection change to another controller server is needed in 520. If the connection change to another controller server is needed, the server connection apparatus commences a procedure for connection change to another controller server.

The connection change is a procedure to migrate a network device connected to an abnormal controller server to another controller server. Either or both of a SHUTDOWN packet that requests connection termination and a TCP SYN packet that requests connection establishment are transmitted in 530. Also, the server connection apparatus performs at least one of operations including change, deletion, and addition of the controller server in 540. For example, if it is detected that controller server 1 111 has entered into a disabled state, the server connection apparatus selects a new master controller server for all network devices 120 that are connected to the disabled controller server 1 111. If the controller server 1 111 in a disabled state has been a master controller server for network device 1 121, a slave controller server, if any, of the network device 1 121 is switched to a new master controller device for the network device 1 121. If there were no slave controllers, the network device 1 121 is left to attempt re-connection to the controller server. Also, if the disabled controller server 111 had been a slave server of the network device 1 121, the server connection apparatus lets the network device 1 121 autonomously restore the slave connection.

In another exemplary embodiment, in a case where a traffic load is generated over a predetermined threshold in a selected controller server, or where a new controller server is added, the controller server connected to the network device is changed to another controller server. For example, when it is determined that there is an excessive amount of traffic load in a controller server 1 111, the controller 140 may migrate all or some of the network devices that are using the controller server 1 111 as their master to another controller server. If the controller 140 were to migrate the network device 1 121 from a current controller server to another controller server, the controller 140 may check whether or not a slave controller server connected to the network device 1 121 exists.

If the controller server 2 112 is the connected slave controller server, the controller 140 sends a message to the controller server 2 112 to instruct it to change its role from a slave to a master with respect to the network device 1 121. Also, the controller sends a message to the controller server 1 111 to instruct it to change its role from a master to a slave with respect to the network device 1 121. Each controller server 1 and 2 111 and 112 that has received the message that informs the change of role sends a message to the network device 1 121 to indicate that its role has changed. The message to be sent to indicate the role change may be a ROLE_REQUEST message of OpenFlow protocol. In the absence of a slave controller server connected to the network device 1 121, the controller may send a FLOW_DEL message to the network connector to delete connection information between the network device 1 121 and the controller server 1 111 and also to delete internally stored connection information. In addition, the controller sends a message to the controller server 1 111 through the network connector to forcibly disconnect the controller server 1 111 from the network device 1 121. The disconnected network device 1 121 may attempt re-connection to the controller server 110 to recover from the forcibly terminated connection and this connection attempt may be routed to another controller server that has a smaller load. The process described above may be repeated for all of the network devices subject to migration to different controller servers. There are various methods that determine whether excessive traffic load is applied or not, and such methods are not limited to any one in particular.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A server connection apparatus comprising:
a network connector configured to connect a plurality of controller servers capable of functioning as OpenFlow protocol-based SDN controllers and a plurality of network devices on a data plane, and relay transmission and reception of data between the controller servers and the network devices; and
a controller configured to create a list of available controller servers by monitoring an operational state of each controller server, select a particular controller server to be in charge of controlling a network device in response to a received request, and then control connection relationships between the plurality of controller servers and the plurality of network devices based on the selection result.

2. The server connection apparatus of claim 1, further comprising:
a list storage configured to store a list of connection relationships between the plurality of controller servers and the plurality of network devices.

3. The server connection apparatus of claim 1, wherein the network connector issues a query to the controller regarding packet processing in response to receiving a packet indicating execution or termination of run-time software from any of the plurality of controller server.

4. The server connection apparatus of claim 1, wherein, in response to receiving an instruction to process a packet or a request for connection to a controller server from a network device, the network connector requests the controller to select a particular controller server and transmit the packet to the selected controller server.

5. The server connection apparatus of claim 3, wherein the controller checks a packet type of a packet received through the network connector and identifies an operational state of each controller server based on execution or termination status of run-time software of the each controller server.

6. The server connection apparatus of claim 1, wherein the controller selects a controller server that is in charge of a particular network device from the plurality of controller servers with reference to packet header fields, existing connections between the network devices and the controller servers, and an amount of traffic on each controller server.

7. The server connection apparatus of claim 1, wherein the controller selects one controller server as a master controller server from the plurality of controller servers and determines the remaining controller servers as slave controller servers.

8. The server connection apparatus of claim 1, wherein the controller performs at least one of operations including change, deletion, and addition of the selected controller server based on a received feedback about the operational state of each controller server.

9. The server connection apparatus of claim 8, wherein the controller changes or deletes a previously connected controller server or adds a new controller server by using a packet that indicates termination of execution of run-time software of the controller server and a packet that requests connection to the controller server.

10. The server connection apparatus of claim 9, wherein when an amount of traffic load generated in the selected controller server is greater than a predetermined threshold, the controller adds a new controller server or changes the current controller server to another controller server.

11. A server connection method comprising:
a preparation process comprising creating a list of available controller servers among a plurality of controller servers by monitoring an operational state of each controller server in a run-time environment;
an execution process comprising, in response to receiving a request for instruction to process a packet or a request for connection to a controller server from a network device on a data plane, selecting a particular controller server to be in charge of controlling a network device from among the plurality of controller servers, and controlling connection relationships between the plurality of controller servers and the plurality of network devices based on the selection result; and
a monitoring process comprising performing at least one of operations including change, deletion, and addition of the selected controller server based on a received feedback about the operational state of each controller server.

12. The server connection method of claim 11, further comprising:
storing a list of connection relationships between the plurality of controller servers and the plurality of network devices.

13. The server connection method of claim 11, wherein the preparation process comprises checking a packet type of a packet received through a network connector and identifying an operational state of each controller server based on execution or termination status of run-time software of the each controller server.

14. The server connection method of claim 11, wherein the execution process comprises selecting a controller server that is in charge of a particular network device from the plurality of controller servers with reference to packet header fields, existing connections between the network devices and the controller servers, and an amount of traffic on each controller server.

15. The server connection method of claim 11, wherein the execution process comprises selecting one controller server as a master controller server among the plurality of controller servers and determining the remaining controller servers as slave controller servers.

16. The server connection method of claim 11, wherein the monitoring process comprises changing or deleting a previously connected controller server or adding a new controller server by using a packet that indicates termination of execution of run-time software of the controller server and a packet that requests connection to the controller server.

17. The server connection method of claim 11, wherein the monitoring process comprises, when an amount of traffic load generated in the selected controller server is greater than a predetermined threshold, adding a new controller server or changing the current controller server to another controller server.
